(19) United States
(12) Patent Application Publication
(10) Pub. No.: US 2013/0150148 A1
(43) Pub. Date: Jun. 13, 2013

(54) High Value Wagering Game

(71) Applicant: Paradigm Table Games, Inc., Rancho Santa Margarita, CA (US)

(72) Inventor: Michael S. Templeman, Trabuco Canyon, CA (US)

(73) Assignee: PARADIGM TABLE GAMES, INC., Rancho Santa Margarita, CA (US)

(21) Appl. No.: 13/693,380

(22) Filed: Dec. 4, 2012

Related U.S. Application Data
(60) Provisional application No. 61/568,014, filed on Dec. 7, 2011.

(51) Int. Cl. G07F 17/32

(52) U.S. Cl. CPC G07F 17/326; G07F 17/3258
USPC 463/22; 463/25

(57) ABSTRACT

A player wagers on the outcome of a comparison of two random numbers that are generated using a plurality of random number generating devices. According to one embodiment the random number generating devices comprise dice and cards. A player bets on the outcome of a comparison of a numerical value generated by a roll of two dice and another numerical value generated by the selection of a card from a deck of cards. At the beginning of play the player places multiple wagers based upon a prediction as to whether the dice value or the card value will be higher. During each round of play, opportunities are provided to withdraw one or more of the wagers.

### CROSS REFERENCE TO RELATED APPLICATIONS

This application claims the benefit of U.S. Provisional Application No. 61/568,014, entitled “High Side Dice and Card Wagering Game,” filed on Dec. 7, 2011, which such application is incorporated herein by reference in its entirety.

### 1. FIELD OF INVENTION

Embodiments of the present invention generally relate to wagering games. More particularly, this relates to methods and apparatuses for playing a new type of wagering game especially for use in casino gaming, both in electronic video and live table formats.

### 2. BACKGROUND

Wagering games are a prominent form of entertainment today. Gambling establishments, such as casinos, are appearing in every region. There are many wagering games, including bingo, roulette, card games such as blackjack, dice games such as craps and slot machines. Some people are attracted to wagering games because they experience a different feeling of excitement every time they bet in certain types of games. Also some people engage in gambling activities just for the sake of having fun.

Wagering activities include state lotteries; pari-mutuel betting on horses, greyhounds, and jai-alai; sports book-making; card games; keno; bingo; slot machines; video poker machines; video keno machines; video blackjack machines; and video roulette machines. These activities have grown greatly, especially when considering that most have only recently become legalized in many jurisdictions.

Casino gaming is a large part of the commercial gambling market. Customers gamble by playing slot machines or other games of chance (e.g., craps, roulette, baccarat) and some skill (e.g., blackjack, poker). Games usually have mathematically-determined odds that ensure the house has an advantage over the players at all times. This advantage is called the house edge. In games such as poker where players play against each other, the house takes a commission.

Casino-style gaming continues to grow in popularity, due in part to the rise in new casino destinations and the expansion of existing casino locales. A casino usually offers so-called banked games, i.e., where the house is banking the game and basically acting as a participant, and has a stake in who wins. On the other hand with a non-banked game, like the lottery, the operator does not care who wins.

For many players the main goal of wagering games is recreation. However some players can become bored with any given game at which point they likely will play that game less frequently. Thus there is a need for wagering games that are new, relatively simple to learn and play, and provide the excitement and interest necessary for entertainment.

### SUMMARY OF CERTAIN EMBODIMENTS

Broadly speaking, certain embodiments of the invention relate to a casino-style game wherein a player wagers on the outcome of a comparison of two random numbers generated using various random number generating devices.

According to one embodiment, the random number generating devices comprise dice and cards. A player wagers on the outcome of a comparison of a numerical value generated by a roll of two dice and another numerical value generated by the random selection of a single card from a deck of cards. Prior to the beginning of play the player places one or more wagers based upon the player's prediction as to whether the dice value or the card value will be higher. During each hand or round of play, the player has opportunities to withdraw one or more of the wagers.

According to another embodiment three wagers by a player are established. All of the three wagers are based upon a prediction by the player of a first game outcome or a second game outcome. The first game outcome is a future combined value being greater than a future second value, and the second game outcome is the future second value being greater than the future combined value. The future combined value is the sum of a future randomly generated first number and a future randomly generated second number, whereas the future second value is a future randomly generated third number. A present first random number and a present second random number are generated using at least one random number generating device, wherein each of the present first and second random numbers is a value between 1 and 6, inclusive. The present first random number is revealed to the player, after which the player is provided with a first option that allows the player to retrieve one of the three wagers. Next the present second random number is revealed to the player. A second option is provided after the present second random number is revealed. This option allows the player to retrieve another one of the three wagers. A present third random number having a value between 1 and 13, inclusive, is generated using a third random number generating device.

A remaining wager is paid, i.e., the player wins, if a present combined value is greater than the present third random number and if the prediction is the first game outcome. The present combined value is a sum of the present first random number and the present second random number. Also the remaining wager is paid if the present third random number is greater than the present combined value and if the prediction is the second game outcome. The remaining wager is settled if the present combined value is equal to the present third random number. According to different embodiments the settling of the remaining wager is returning the remaining wager, or taking some or all of the remaining wager, or paying the remaining wager.

The remaining wager itself is the sum of the three wagers if the first and the second options were not exercised, or it is the sum of two of the three wagers if one of the first and the second options was exercised and if the other of the first and the second options was not exercised. Or alternatively the remaining wager is equal to only one of the three wagers if both of the first and the second wagers were exercised.

In another aspect the generating of the present first and second random numbers comprises generating the present first random number using a first random number generating device and generating the second random number using a second random number generating device that is a different device than the first random number generating device.

In another aspect the generating of the present first and second random numbers comprises generating these random numbers using no more than one random number generating device.

In another aspect each of the three wagers is equal in amount to the others of the three wagers.

In another aspect at least a portion of the three wagers is taken by the house and game play ends if the present combined value is a value of 7. This taking of the at least a portion of the three wagers occurs after the present second random number is revealed and prior to the providing of the second option. Because game play ends at this point (when the present combined value is 7), the following actions are not taken for the current round of play:
the providing of the second option;
the generating of the present third random number;
the paying of the remaining wager if the present combined value is greater than the present third random number and if the prediction is the first game outcome;
the paying of the remaining wager if the present third random number is greater than the present combined value and if the prediction is the second game outcome, and
the settling of the remaining wager if the present combined value is equal to the present third random number.

In another aspect the taking of the at least the portion of the three wagers if the present combined value is a value of 7 includes taking all of two of the three wagers, or alternatively taking a portion of each of two of the three wagers, or alternatively still, taking a portion of all of the three wagers if the first option was not exercised.

In yet another aspect, the at least one random number generating device is a first die and a second die, each having six faces numbered one through six. The third random number generating device is at least one deck of a plurality of cards, wherein each card has a point value between 1 and 13, inclusive. The generating of the present first random number and the present second random number includes rolling the first die and the second die. The generating of the present third random number includes dealing one card from the deck of cards.

In another aspect, the paying of the remaining wager if the present combined value is greater than the present third random number and if the prediction is the first game outcome, includes paying the remaining wager at a payout odds of 1:1. Similarly the paying of the remaining wager if the present third random number is greater than the present combined value and if the prediction is the second game outcome, includes paying the remaining wager at a payout odds of 1:1.

In another aspect, a bonus amount is paid if the present first random number and the present second random number are equal to one another and if the present combined value is equal to the present third random number. Also the remaining wager is returned to the player under these conditions. In some embodiments the bonus amount is a multiple of one of the three wagers, wherein the multiple is equal to a value of three or a value of four.

In another aspect, the at least one random number generating device is a first deck of cards and a second deck of cards. The first deck of cards and the second deck of cards each comprises at least one each of an Ace card, a Two card, a Three card, a Four card, a Five card, and a Six card. Also the first and second decks include no cards other than Aces, Twos, Threes, Fours, Fives, and Sixes. The generating of the present first random number and the present second random number includes respectively dealing one card from the first deck of cards and dealing one card from the second deck of cards.

In another embodiment, a system comprises a device having a memory and a processing unit coupled to the memory and capable of executing at least one software routine. The system further comprises programming logic configured for execution by the processing unit and operable to perform the steps of any of the above-described embodiments.

In yet another embodiment, a non-transitory, tangible, computer-readable storage medium is provided. The storage medium contains an executable program that, when executed by a processor, causes the processor to perform the steps of any of the above-described embodiments.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a simplified diagram of a playing table layout according to one embodiment of the invention;

FIGS. 2A, 2B and 2C are a simplified flow diagram illustrating certain of the steps performed in playing a game according to one embodiment of the invention;

FIG. 3 is a simplified flow diagram illustrating certain of the steps performed in playing a game according to an alternative embodiment of the invention;

FIG. 4 is a simplified flow diagram illustrating certain of the steps performed in playing a game according to yet another alternative embodiment of the invention; and

FIG. 5 is a simplified functional block diagram of an electronic, CPU-based hardware environment according to an embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

Embodiments of the invention include a wagering game that employs a plurality of random number generating devices for generating three random numbers at different points in time during game play. Initially a player places three wagers, all of which are based upon his/her prediction of one of two game outcomes: either a sum of the first two random numbers will be greater than a third random number, or the third random number will be greater than the sum of the first two random numbers. After the wagers are placed the first two random numbers are generated. After the first random number is revealed to the player, he/she is given an option to retrieve one of the three wagers. After the player has made a decision on the option, the second random number is revealed to the player. A second option is then provided whereby the player may retrieve another one of the three wagers. Thus after the player has made a decision on the second option, the player may have one wager, two wagers or all three wagers still in play depending upon the number of options, if any, that were exercised. The third random number is generated, revealed to the player and compared with the sum of the first and second random numbers.

The player wins and a remaining wager is paid at a payout odds of 1:1 if he/she accurately predicted the game outcome, i.e., that the sum of the first two random numbers was either greater than or less than the third random number. The remaining wager is equal to the amount of wagers that were at risk at this point in the game, depending upon whether none or one or both of the options had been exercised. A payout odds of 1:1 corresponds to a winnings of one dollar (or chip or other betting unit) for each dollar/unit of the remaining wager. Thus for example if the remaining wager amounted to five dollars, then a winning payout odds of 1:1 would correspond to the player receiving a return of the original five dollars plus an additional amount of five dollars. (However alternative embodiments of the invention include payout odds that are other than 1:1.)

If the sum of the first two random numbers turns out to be equal to the value of the third random number, then the remaining wager is returned to the player without any winnings or losses of the remaining wager. Additionally however a bonus is paid to the player if the sum of the first two random numbers turns out to be equal to the third random number and if each of the first two random numbers is equal to one another. Thus for example if each of the first two random numbers was a value of 3, and the third random number was a value of 6, then the bonus would be paid and the remaining wager would be returned to the player. On the other hand if for example the first random number was a value of 4, the second random number was a value of 2, and the third random number was a value of 6, then the bonus would not be paid, although the remaining wager still would be returned.

According to an alternative embodiment, the play proceeds as described above up to and including the point of revealing the second random number to the player. At that point a determination is made whether the sum of the first and second random numbers equals the value of seven. If this does equal the value of seven, then the player loses two of the three wagers, i.e., those wagers are taken. If the first option had not been exercised by the player, then the remaining one of the three wagers is returned to the player. At this point the game terminates. On the other hand if the sum of the first and second random numbers does not equal seven, then the play proceeds as described above without the player losing any wagers at this point in the game.

According to an alternative embodiment, two random number generating devices are two standard, six-sided dice, and the third random number generating device is at least one standard deck of 52 playing cards which have been shuffled. Each card in the deck is assigned a value from 1 to 13, inclusive, which is based on the rank of each card. As before the player places three wagers on the higher of two hand values which in this embodiment are referred to as “the Dice hand” and “the Card hand.” The first hand value (the Dice hand) is determined by the roll of the two dice. The second hand value (the Card hand) is determined by the draw of a single card from the deck. Card values equal the number displayed on each card with Aces having the value of 1, Jacks having the value of 11, Queens having the value of 12 and Kings having the value of 13. A winning hand pays even money, i.e., a payout odds of 1:1.

As previously mentioned, the player begins by making three equal bets or wagers on either the Dice hand or the Card hand, whichever the player predicts will be the higher. After the three wagers are made, two dice are rolled. (The dice may be rolled simultaneously or at separate points in time.) The first of the two dice (and only the first die) is revealed to the player. After it is revealed, the player has an option and decides whether to leave all three wagers in play, or to withdraw one of the wagers. Next, the second die is revealed to the player. If the two dice add up to a value of 7, the player loses two of the three wagers, and game play ends. (The third wager is returned to the player if the option was not exercised.) On the other hand if the two dice do not equal 7, the player is provided with a second option and decides whether to leave the remaining wagers in play or to withdraw another one of the remaining wagers. Then one card is drawn from the deck to determine the Card hand. This is compared with the Dice hand, and the higher of the two is considered to be the winning hand. If the Card hand is equal to the Dice hand, there is a push, i.e., the remaining wagers are returned to the player. However if the dice roll doubles (i.e., each one of the dice is equal to the other) and the Card hand is equal to the Dice hand, the remaining wagers are returned, and additionally the player wins a bonus amount equal to a multiple of one of the wagers, such as for example, triple the amount of one of the wagers.

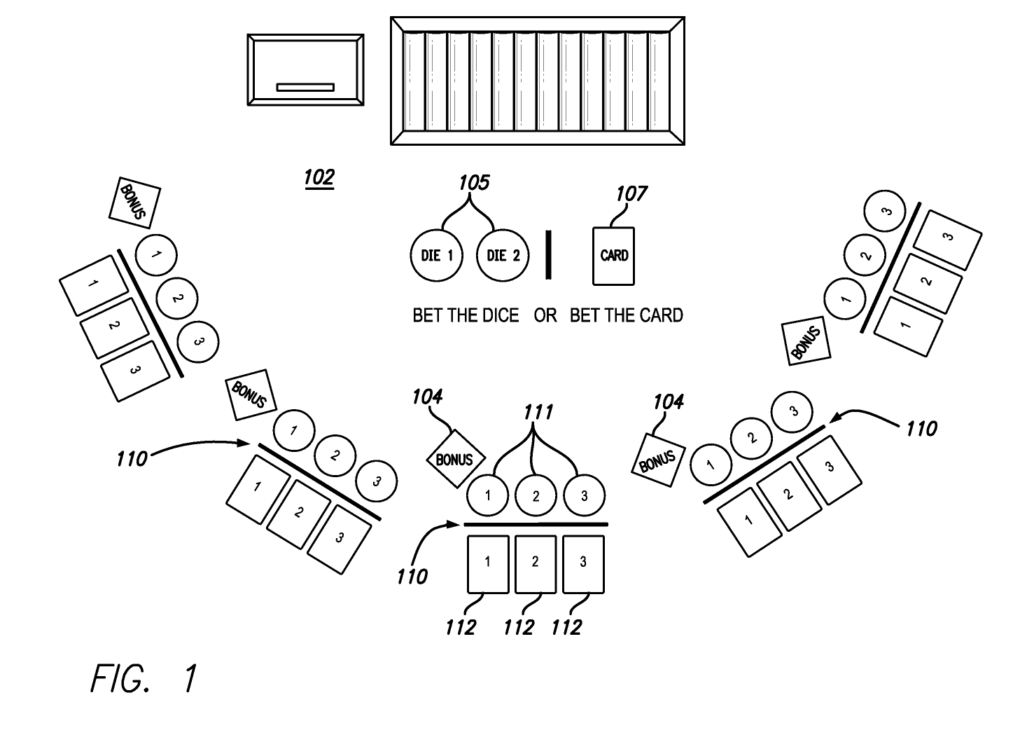

FIG. 1 is a simplified diagram of a playing table layout 102 according to one embodiment of the invention. The layout 102 includes two circles 105 on which to place two Pai Gow Cups that are used to roll the two dice. Also included is a rectangular area 107 for designating a location to place a card after it has been dealt from a deck of cards. Around the perimeter of one edge of the table surface is a plurality of individual player betting areas 110 for use by a plurality of players. Within each of the individual player betting areas, there are three circles 111 for placing three wagers on the table to indicate a player's prediction of a first game outcome that a future combined dice value will be higher than a future card value. Also there are three squares 112 for placing the three wagers on the table to indicate the player's prediction of a second game outcome that the future card value will be higher than the future combined dice value. Finally each betting area 110 includes a diamond-shaped area 104 on which the player may place an optional wager (sometimes referred to herein as a “Bonus wager”). At the start of game play the player must place all three of his/her wagers in the circles 111 or all three in the squares 112. The player may not mix the three wagers and may not place one or two wagers in the circles 111 and the balance of the wagers in the squares 112. Also the player must place a wager in the diamond-shaped area 104 at this time if he/she desires to exercise his/her option to make the Bonus wager.

While FIG. 1 illustrates the table layout 102 according to certain embodiments, it will be appreciated that alternative table layouts and arrangements can be used without departing from the spirit of the inventions. The illustrated table layout 102 is just one of many arrangements that can be employed to facilitate the placement of wagers by one or more players.

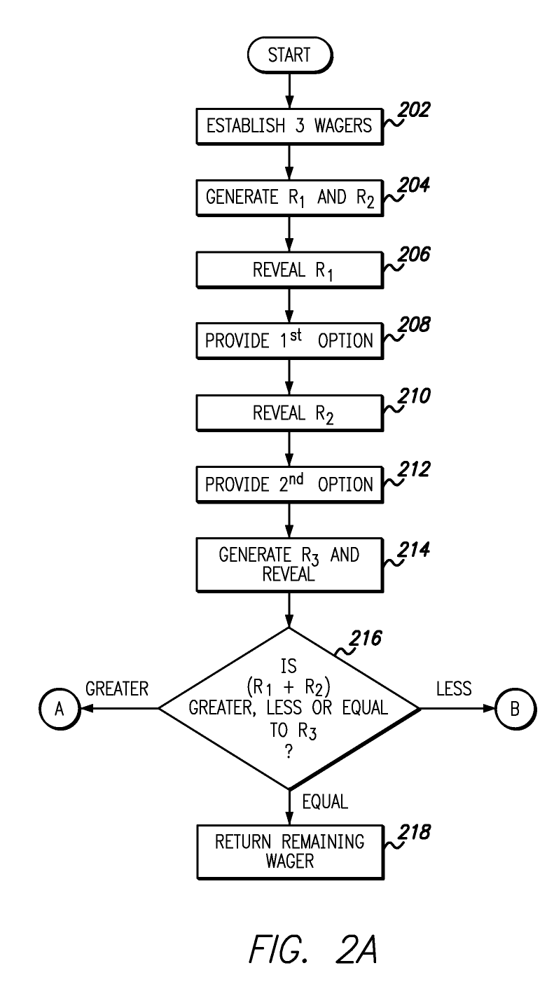

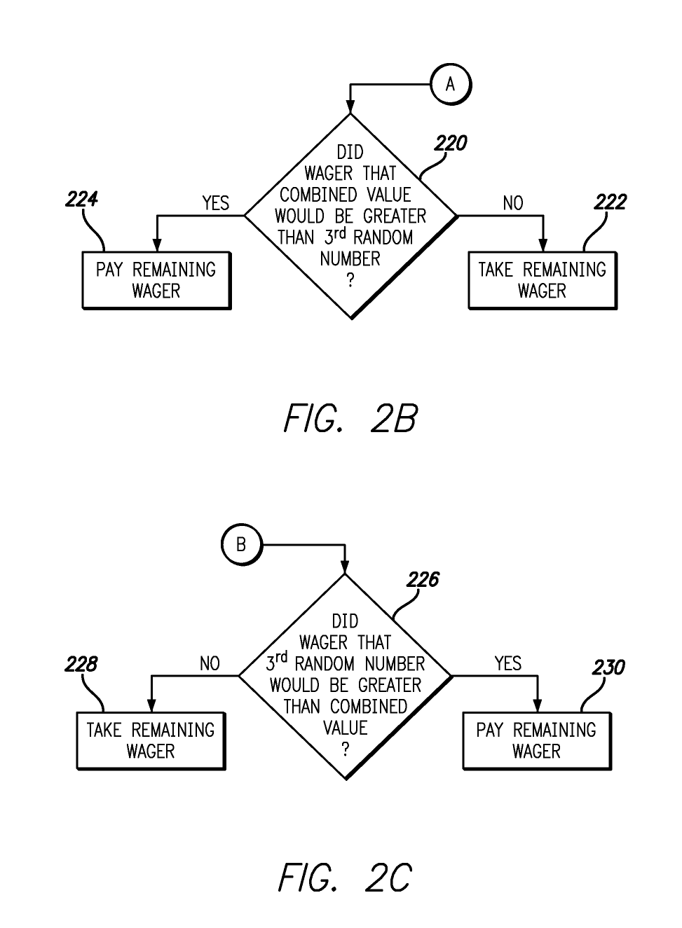

FIGS. 2A-2C are a simplified process flow diagram of a method of playing a wagering game according to one embodiment of the invention. In this embodiment there are established three wagers by a player based upon the player's prediction of a first or second game outcome. (Step 202) The first game outcome is a future combined value being greater than a future second value, and the second game outcome is the future second value being greater than the future combined value. The future combined value is the sum of a future first random number and a future second random number, each of which will be a value between one and six, inclusive. The future second value is a future third random number having a value between one and thirteen, inclusive. All three wagers must be based upon the same game outcome. In other words the player may not split the three bets between the two outcomes. Then first and second random numbers (R₁ and R₂) are generated using at least one random number generating device. (Step 204) Each of these two random numbers has a value between one and six, inclusive. In some embodiments one random number generating device is actuated on two separate occasions for generating the two random numbers. In other embodiments the one random number generating device is actuated only once and is configured to generate two random numbers in response to the single actuation. In yet other embodiments there are two, different random number generating devices, each of which is actuated once for generating one random number each.

Next the first random number (R₁) is revealed to the player. (Step 206) The player, who now has knowledge of the first random number, is then provided with an option that allows him/her to retrieve one of the three wagers. (Step 208) Then the second random number (R₂) is revealed to the player. (Step 210) The player, who now also has knowledge of the second random number, is next provided with a second option that allows him/her to retrieve another one of the three wagers. (Step 212) Then a third random number (R₃) is generated using a third random number generating device and is revealed to the player. (Step 214) The third random number has a value between one and thirteen, inclusive.

A determination is made whether a combined value is greater than or less than or equal to the third random number, where the combined value is the sum of the first and second random numbers (R₁+R₂). (Step 216) If the combined value is equal to the third random number (R₃), then a remaining wager is returned to the player. (Step 218) The remaining wager is: (a) one of the original three wagers if the first and second options were exercised by the player; or (b) two of the three wagers if only one of the two options was exercised; or (c) all three of the wagers if none of the two options were exercised. Returning to step 216 if on the other hand the combined value is greater than the third random number, then a determination is made whether at the beginning of play the player had wagered on the first game outcome, i.e., that the future combined value would be greater than the future second value. (Step 220) If the player had wagered on the first game outcome, then the remaining wager is paid to the player. (Step 224) In one embodiment the payout odds are 1:1. On the other hand if the player did not wager on the first game outcome, then the remaining wager is taken, i.e., the player loses the remaining wager. (Step 222)

Returning again to step 216 if on the other hand the combined value is less than the third random number, then a determination is made whether at the beginning of play the player had wagered on the second game outcome, i.e., that the future second value would be greater than the future combined value. (Step 226) If the player had wagered on the second game outcome, then the remaining wager is paid to the player. (Step 230) On the other hand if the player did not wager on the second game outcome, then the remaining wager is taken, i.e., the player loses the remaining wager. (Step 228)

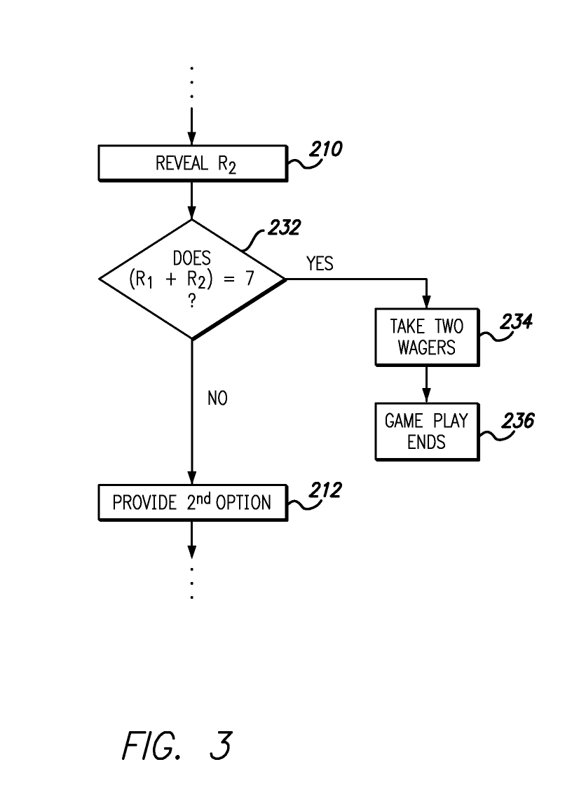

FIG. 3 is a simplified process flow diagram of a method of playing a wagering game according to an alternative embodiment of the invention. In this embodiment game play is similar to that described above in connection with FIGS. 2A-2C, except that here the player loses two of the three wagers and game play terminates if the combined value (i.e., the sum of the first and second random numbers (R₁ and R₂)) is equal to a value of seven. Referring to FIG. 3, game play proceeds in the same manner as that described above for steps 202 through 210 of FIG. 2A, and accordingly most of those steps are not reproduced in this figure. Then after step 210 is completed, a determination is made whether the combined value (R₁+R₂) is equal to a value of seven. (Step 232) If the combined value does equal seven, then two of the three wagers are taken (Step 234), and game play terminates. (Step 236) If the first option had not been exercised earlier in game play, then the remaining one of the three wagers is returned to the player. (In alternative embodiments, however, that remaining wager would be taken along with the other two wagers.) Returning to step 232 if on the other hand the combined value does not equal seven, then play proceeds as described above in connection with step 212 of FIG. 2A where the player, who at this point has knowledge of the second random number, is provided with the second option which allows him/her to retrieve another one of the three wagers. (Step 212) At this point, play then proceeds as described above in connection with the remaining steps 214-230 of FIGS. 2A-2C.

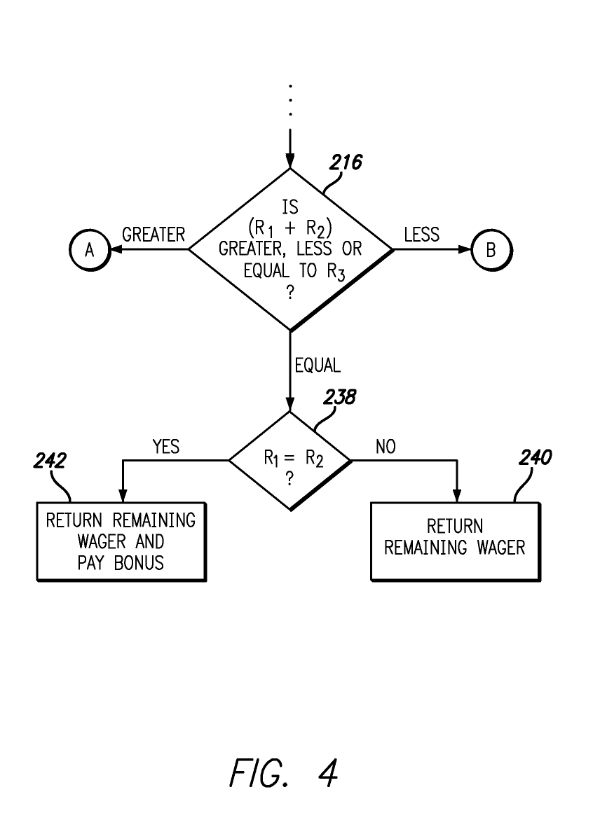

FIG. 4 is a simplified process flow diagram of a method of playing a wagering game according to yet another alternative embodiment of the invention. In this embodiment game play is similar to that described above in connection with FIGS. 2A-2C, except that here a bonus amount is paid to the player (in addition to the return of his/her remaining wager) if two conditions are met: (a) the first and second random numbers (R₁, R₂) are equal to one another; and (b) the combined value (R₁+R₂) is equal to the third random number (R₃). Referring to FIG. 4, game play proceeds in the same manner as that described above for steps 202 through 216 of FIG. 2A, and accordingly most of those steps are not reproduced in this figure. If at step 216 it is determined that the combined value is equal to the third random number, then a determination is made whether the first and second random numbers (R₁, R₂) are equal to one another. (Step 238) If they are not equal to one another then the remaining wager is returned to the player (Step 240), but a bonus is not paid. On the other hand if the first and second random numbers are equal to one another, then a bonus amount is paid and the remaining wager is returned to the player. (Step 242) Returning to step 216 if on the other hand the combined value does not equal the third random number, then play proceeds to step 220 or step 226 of FIGS. 2A-2C, depending upon whether the combined value was greater or less than the third random number. At this point play then proceeds as described above in connection with the remaining steps 220-230 of FIGS. 2A-2C.

FIGS. 2A-2C, 3 and 4 describe various embodiments of the invention. As yet another embodiment all of the steps can be combined into one game that is played in accordance with the combination of all of FIGS. 2A-2C, 3 and 4. In other words under this embodiment game play proceeds as described, including: (a) that the player loses two of the three wagers and game play terminates if the combined value (i.e., the sum of the first and second random numbers (R₁ and R₂)) is equal to seven, and (b) that the bonus amount is paid (in addition to the return of the remaining wager) when the first and second random numbers (R₁, R₂) are equal to one another and the combined value (R₁+R₂) is equal to the third random number (R₃).

In yet another embodiment, at the beginning of game play the player is offered an option to make yet another wager (sometimes referred to herein as a “Bonus wager”) that the difference, or “spread”, between the third random number (R₃) and the combined value (R₁+R₂) will be greater than a predetermined amount. The payout on this Bonus wager has the potential of being a high multiple of this wager and is paid in accordance with a predetermined pay scale having a plurality of payout odds that increase as the difference, or “spread”, increases in magnitude.

According to this embodiment, the player makes this optional Bonus wager at the same time as making his/her initial three wagers. The player will not have an opportunity to withdraw the Bonus wager once made. Play proceeds as described above in connection with FIGS. 2A-2C, 3 and 4 (or any combination of these figures), but with the following additions and exceptions: The Bonus wager is resolved after both of the first and second random numbers (R₁, R₂) have been revealed and after the third random number (R₃) is generated and revealed. For example the Bonus wager is resolved after step 214 of FIG. 2A. Also according to a variation of the embodiment of FIG. 3 on those occasions when the first and second random numbers (R₁, R₂) are equal to a value of 7, the game play does not end after two of the initial three wagers are taken. Rather under this alternative embodiment when the first and second random numbers (R₁, R₂) are equal to a value of 7, then two of the original three wagers are taken as before, but play proceeds so that the third random number (R₃) is generated and revealed. This is done so that the difference or spread can be determined as described above and the Bonus wager resolved. Then at this point game play would terminate under this alternative embodiment.

Thus in resolving the Bonus wager the value of the third random number (R₃) is compared with the combined value (R₁+R₂) and the difference (or “spread”) between the two values is determined. That is, if the third random number (R₃) turns out to be less than the combined value (R₁+R₂), then the third random number (R₃) is subtracted from the combined value (R₁+R₂) to determine the spread. On the other hand, if the third random number (R₃) turns out to be greater than the combined value (R₁+R₂), then the combined value (R₁+R₂) is subtracted from the third random number (R₃) to determine the spread. Regardless of which method is used to determine the spread, once it has been determined this amount is compared to a predetermined pay scale. If the spread is less than a predetermined minimum amount, the Bonus wager loses. If the spread is equal to or greater than the predetermined amount, then the Bonus wager wins and is paid according to the pay scale that provides for a greater payout as a function of a larger spread magnitude. The player need not predict the correct game outcome to win the Bonus wager.

The pay scale can be designed with any number of different parameters, payouts or predetermined minimum amounts and not impact the spirit of certain embodiments the invention. An exemplary pay scale having higher payouts as the magnitude of the difference or spread, is increased, is set forth in the following pay table:

| Spread | Payout |
|---|---|
| 6 | 1 to 1 |
| 7 | 2 to 1 |
| 8 | 3 to 1 |
| 9 | 5 to 1 |
| 10 | 10 to 1 |
| 11 | 30 to 1 |

Referring to this table, if for example the combined value (R₁+R₂) is a value of 2, and the third random number (R₃) is a value of 8, the spread between these values would be 6. The wager would be paid 1 to 1 (i.e., at a payout odds of 1:1) according to the pay table. However, if the combined value (R₁+R₂) is a value of 2 and the third random number (R₃) is a value of 10, the spread would be 8 and the wager would be paid at a higher amount, such as 3 to 1, according to the above pay table. (By a payout of “3 to 1,” this would mean, for example, that the player would receive back four dollars for every one dollar bet, etc.)

It should also be noted that similar spread magnitudes and similar payouts can be achieved where a combined value (R₁+R₂) is greater than a third random number (R₃) value, such as for example when a combined value (R₁+R₂) is a value of 10 and a third random number (R₃) is a value of 4. This condition would also result in a spread of 6 and would similarly be paid 1 to 1 according to the exemplary pay table. A spread of 8 would also result if the combined value (R₁+R₂) is a value of 10 and the third random number (R₃) is a value of 2. The resulting spread of 8 would similarly be paid 3 to 1 per the exemplary pay table. Finally it should be noted that in the above example, any spread that is less than the predetermined amount of 6 will result in a loss of the Bonus wager. Also it should be noted that while the foregoing embodiment does not require a correct prediction of the game outcome as a condition for winning the Bonus wager, in an alternative embodiment the Bonus wager is paid if the spread is equal to or greater than the predetermined amount and only if the player also predicts the correct game outcome at the beginning of game play.

According to yet another alternative embodiment, the first and second random numbers are generated by random number generating devices comprising two, standard, six-sided dice. The present first random number of 1 to 6, inclusive, is generated by rolling the first six-sided die thus providing a first die value, and the present second random number of 1 to 6, inclusive, is generated by rolling the second six-sided die thus providing a second die value. At the appropriate point in the game the two die values are summed to produce a present combined dice value from 2 through 12, inclusive. According to this embodiment the third random number is generated by dealing a card from at least one shuffled deck of 52 standard playing cards to provide a present card value. Thus the third random number generating device is at least one deck of 52 standard playing cards that includes four suits of cards with each suit having cards with face designations or indicia associated with point values 2 through 10, as well as a Jack, Queen, King and Ace. When the card is drawn from at least one properly shuffled deck, the third random number between 1 and 13, inclusive, is generated according to a point value assigned to the card face indicia of each card as set forth in the following chart:

| Card Face | |
|---|---|
| Indicia | Assigned Point Value |
| Ace | 1 |
| Two | 2 |
| Three | 3 |
| Four | 4 |
| Five | 5 |
| Six | 6 |
| Seven | 7 |
| Eight | 8 |
| Nine | 9 |
| Ten | 10 |
| Jack | 11 |
| Queen | 12 |
| King | 13 |

According to an embodiment that employs two, standard dice and at least one deck of cards, play would proceed as follows. Three wagers by a player are established wherein all of the three wagers are based upon a prediction by the player of a first game outcome or a second game outcome. The first game outcome is a future combined dice value being greater than a future card value, where the future combined dice value is the sum of a future first die value and a future second die value. The second game outcome is the future card value being greater than the future combined dice value. A present first die value and a present second die value are generated by rolling a first die and a second die, wherein each of the present first and second die values is a value between 1 and 6, inclusive. The present first die value is revealed to the player. After this is revealed the player, who at this point has knowledge of the present first die value, is provided with a first option that allows him/her to retrieve one of the three wagers. Then after the player has made a decision on exercising the first option and after it is exercised if the player so decides, the second die value is revealed to the player.

At this point a determination is made whether a present combined dice value is a value of 7, where the present combined dice value is a sum of the present first die value and the present second die value. If the present combined dice value is equal to 7, then two of the three wagers are taken (i.e., the player loses those two wagers), and game play ends at this point. (Also if the player had not exercised the first option, then the remaining one of the wagers is returned to the player.) If the present combined dice value is not 7, then play continues as follows:

A second option is provided to the player after the second die value is revealed to him/her, which allows the player to retrieve another one of the three wagers. Then after the player has made a decision on exercising the second option and after it is exercised if the player so decides, a present card value is revealed to the player. The present card value was generated by dealing one card from at least one deck of a plurality of cards, wherein each one of the plurality of cards has a point value between 1 and 13, inclusive. Then a remaining wager is paid to the player (i.e., the player wins the remaining wager) if the present combined dice value is greater than the present card value and if the prediction is the first game outcome. Similarly the remaining wager is paid if the present card value is greater than the present combined dice value and if the prediction is the second game outcome. On the other hand if the present combined dice value is equal to the present card value, the remaining wager is returned to the player.

The remaining wager is (a) the sum of all three wagers if the first and the second options were not exercised, (b) the sum of two of the three wagers the first or the second option was exercised and if the remaining option was not exercised, or (c) equal to one of the three wagers if both of the first and second options were exercised. When the remaining wager is paid, it is paid at an odds of 1:1 However in alternative embodiments other payout odds may be used.

In the above-described embodiment, two dice are used as random number generating devices to generate two random numbers which are combined for comparison with a third random number that is generated by at least one shuffled deck of 52 standard playing cards. In alternative embodiments, however, additional decks of cards can be substituted as the random number generating devices in place of the one or more dice in order to generate the random numbers from 1 to 6, inclusive. In one embodiment, a first deck of cards is used in lieu of the first die to generate a first card point value. A second deck of cards is used in place of the second die to generate a second card point value. The first and second card point values are summed and compared to a third random number that is generated by using at least one standard deck of 52 playing cards to provide a value between 1 and 13, inclusive. Winning wagers are determined in the same fashion as the embodiments described above using other combinations or types of random number generating devices.

In this alternative embodiment that uses two decks of cards in lieu of the two dice, the first and second decks each are limited only to cards having values between 1 and 6, inclusive. To begin, the player makes three wagers based upon a prediction of one of two game outcomes, i.e., that a future combined value generated by drawing one card each from the first and second decks will be higher than a future value generated by the third deck or alternatively that the future value generated by the third deck will be higher than the future combined value generated by the first and second decks.

Then one card is drawn from the first deck thereby generating a present first random number between 1 and 6, inclusive, and is displayed to the player. After the first card value is displayed, the player is provided with a first option to remove and retrieve one of his/her three initial wagers. A card also is drawn from the second deck thereby generating a second random number between 1 and 6, inclusive, and is displayed to the player. The first and second random numbers are added to determine a present combined card point value between 2 and 12, inclusive. This value substitutes for the combined dice value used in the dice and card embodiment previously described above.

If the combined card point value equals 7, then the player loses two of the three equal wagers and play ends. (If the player had not exercised the first option, then the remaining one of the three wagers is returned to the player.) On the other hand if the combined card point value does not equal 7, the player is given a second option to remove another one of the three initial wagers. Next a card is drawn from the third deck which is comprised of at least one shuffled deck of 52 standard playing cards with 4 suits and with face designations or indicia associated with point values 2 through 10, as well as a Jack, Queen, King and Ace. Thus when a card is drawn from the third deck, a random number between 1 and 13, inclusive, is generated.

The combined card point value is compared with the third card point value. If the combined card point value is higher than the third card point value, then the wagers that were initially made on the corresponding game outcome are paid. Otherwise those wagers are taken. Alternatively, if the third card point value is higher than the combined card point value, then the wagers that were initially made on the alternative game outcome will be paid. Otherwise those wagers are taken. Similar to the previous embodiment if the combined card point value equals the third card point value, all remaining player wagers are returned, unless the first card value equals the second card value in which case a bonus amount is paid to the player in addition to returning all original wagers.

In one embodiment, the first and second decks each comprises at least one each of an Ace card, a Two card, a Three card, a Four card, a Five card, and a Six card—all of which such cards have generally the same appearance as their counterparts as taken from a standard deck of 52 playing cards. Moreover, each of the first and second decks includes no cards other than the Ace, Two, Three, Four, Five and Six cards, and said cards are included in equal quantities of each of the six individual cards.

Certain of the embodiments described above involve a payout odds of 1:1 for winning wagers. It will be appreciated that the invention is not limited to these payout odds only, but rather alternative embodiments can employ payout odds that are other than 1:1. Moreover, while certain of the above-described embodiments involve the use of at least one standard deck of 52 playing cards, alternative styles or types of cards can be used wherein each of the cards nevertheless has indicia corresponding to a point value between 1 and 13, inclusive. Also, alternative embodiments are not limited to two, standard, six-sided dice. Rather these embodiments can employ two, non-standard dice, or only one standard or non-standard die, or three or more standard or non-standard dice.

As previously mentioned, in some embodiments one or more dice are used for generating a random number for comparison with the value of a card that is drawn from at least one deck for generating another random number. In alternative embodiments, cards can be substituted for the one or more dice in order to generate random numbers. When a plurality of players are playing with one dealer, the dice rolled and the card or cards that are drawn from the deck(s) can apply to all players for each round of betting. Thus the same dice and card point value(s) would be applicable to all players. In alternative embodiments however, the dealer can deal the cards so that each of the plurality of players receives his/her own card(s) for each round of betting. Thus there are different card point values appearing on the table wherein each of the card point values is applicable to a different player.

As discussed above in some embodiments the random number generators comprise dice or cards or both. However embodiments of the invention are not limited to these, but rather include any random number generating device. Such devices can include computational or physical devices or both. Examples include:
electronic, processor-driven random number generators;
mechanical random number generators;
electro-mechanical random number generators;
roulette wheels;
disk-shaped objects, such as for example coins, that can be flipped;
spinners;
books containing tables of random numbers;
revolving mechanical reels to display and determine results, such as those used in some types of slot machines;
physical tokens which can be drawn or otherwise extracted from a container or surface, etc. and which have indicia corresponding to numerical values; and
balls, such as, for example, ping-pong balls, which bear indicia corresponding to numerical values, which are disposed in a mixing chamber, and which can be mechanically mixed or agitated, such as for example agitated using blown air or rigid agitators, along with a mechanism for withdrawing the balls from the mixing chamber.

The foregoing disclosure generally pertains to playing wagering games using various types of random number generating devices, such as for example cards and dice, in a live table format. However certain embodiments described herein can be implemented in a computing and software environment for playing in an electronic video format. The following describes an exemplary operating environment in the general context of a personal computer on which is running an operating system and one or more application programs. However it will be recognized that embodiments of the invention can be implemented with other hardware devices, such as for example hand-held devices; computerized, special-purpose gaming machines; mainframe computers; minicomputers; microprocessor-based consumer electronics; set top boxes; etc. Moreover, these computers or other devices can be interconnected so that they may communicate via a network, including a wide area network (WAN), a large area network (LAN), the Internet, etc. Such communications can be via wireless or wired connections. The one or more one software application programs can include data structures, components, applets, program modules, routines, programs, objects, etc., that can all reside on one machine, or alternatively, can be distributed over a plurality of machines, some or all of which can be in communication with one another.

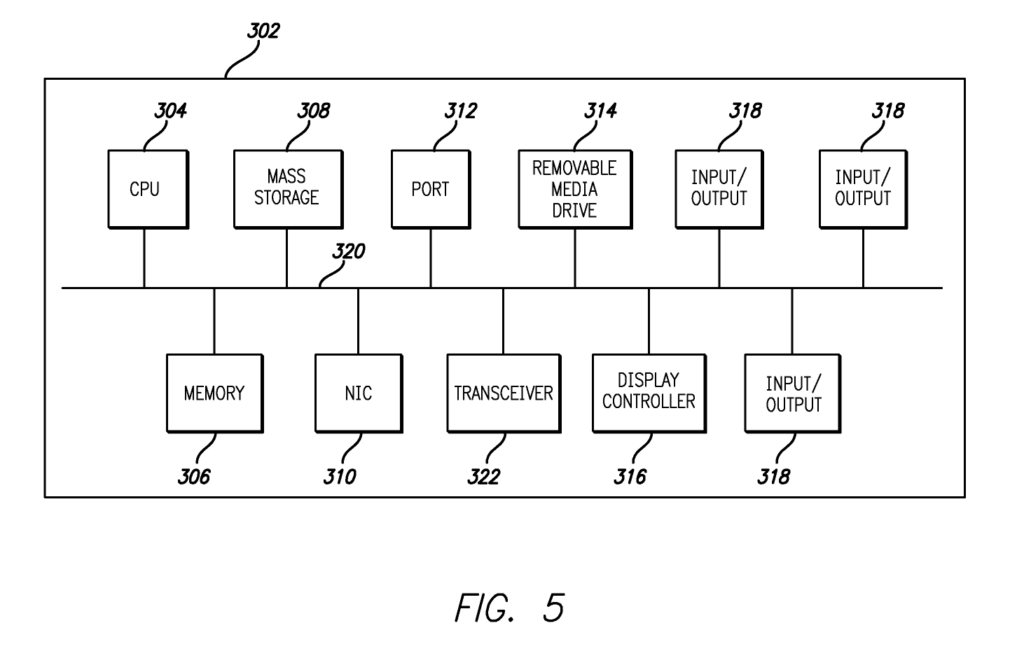

FIG. 5 is a functional block diagram of a computer 302 according to an embodiment of the invention. The computer 302 is used to receive betting-related information and input from a player, including wagering information, bonus betting decisions, etc. The computer 302 also provides text and images on a display relating to the playing of the wagering games, such as for example images of cards and/or dice, of playing chips or currency, pay scale odds, betting amounts, etc.

The computer 302 includes a central processing unit (CPU) 304, a system memory 306, preferably including both high speed random access memory (RAM) and non-volatile memory, such as read only memory (ROM), erasable or alterable non-volatile memory (e.g., flash memory), and a mass storage device 308, such as a hard disk drive or solid state storage drive, for storing operating system programs, data, cryptographic keys, application programs, etc. The computer 302 further includes one or more input/output devices, including, for example, a network interface card (NIC) 310 for wired connections and a transceiver 322 for wireless connections, either or both of which can be for communicating with other devices via a network, such as for example the Internet.

A port 312 for connecting to a portable device, another computer, or other peripheral device, is also included along with one or more removable media drives 314 for reading from, and/or writing to, e.g., diskettes, compact discs, flash drives, DVDs, or other computer readable media, including non-transitory, tangible computer-readable storage media with one or more executable programs stored therein. User interfaces include a display screen controller 316 and a plurality of input and output devices 318, such as, for example, a keyboard, a mouse, a touch screen, a microphone, a sound generator, and a joystick, as well as specialized, gaming-related input/output devices such as currency or playing chip receivers (e.g., coin hoppers, coin acceptors, bill validators, etc.), credit/debit card readers, currency or playing chip dispensers, ticket printers or dispensers, player controls, etc. A bi-directional bus 320 interconnects the above-described components of the system.

The operation of the computer 302 is controlled primarily by programs contained in the system memory 306 and executed by the CPU 304. These programs include program modules for accepting input data and for processing the input data in accordance with the embodiments of the invention described herein. For example, the program includes one or more program modules for receiving betting amount and decision inputs from a player via one or more of the various input/output devices 318, and for providing the player with text and images of cards, dice, betting odds, betting status, payout information, etc. via the display controller 316. It will be appreciated, however, that some or all of the functionality of these program modules could be readily implemented in hardware without departing from the principles of the present inventions.

In view of the above, it will be appreciated that certain embodiments of the invention overcome many of the long-standing problems in the art by providing a casino-style game wherein a player wagers on the outcome of a comparison of two random numbers generated using various random number generating devices. According to one embodiment, the random number generating devices comprise dice and cards. A player bets on the outcome of a comparison of a numerical value generated by a roll of two dice and another numerical value generated by the random selection of a single card from a deck of cards. At the beginning of play the player places multiple wagers based upon his/her prediction as to whether the dice value or the card value will be higher. During each round of play, opportunities are provided to withdraw one or more of the wagers.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A method of playing a wagering game comprising:
establishing three wagers by a player,
wherein all of the three wagers are based upon a prediction by the player of one of a first game outcome and a second game outcome,
wherein the first game outcome is a future combined value being greater than a future second value,
wherein the second game outcome is the future second value being greater than the future combined value, and
wherein the future combined value is the sum of a future randomly generated first number and a future randomly generated second number, and
wherein the future second value is a future randomly generated third number;
generating a present first random number and a present second random number using at least one random number generating device, wherein the present first random number is a value between 1 and 6, inclusive, and wherein the present second random number is a value between 1 and 6, inclusive;
revealing the present first random number to the player;
providing a first option after the revealing of the present first random number, wherein the first option allows the player to retrieve one of the three wagers;
revealing the present second random number to the player;
providing a second option after the revealing of the present second random number, wherein the second option allows the player to retrieve another one of the three wagers;
generating a present third random number using a third random number generating device, wherein the present third random number is a value between 1 and 13, inclusive;
paying a remaining wager if a present combined value is greater than the present third random number and if the prediction is the first game outcome,
wherein the present combined value is a sum of the present first random number and the present second random number;
paying the remaining wager if the present third random number is greater than the present combined value and if the prediction is the second game outcome; and
settling the remaining wager if the present combined value is equal to the present third random number, wherein the settling of the remaining wager is one of returning the remaining wager and taking the remaining wager and paying the remaining wager,
wherein the remaining wager is the sum of the three wagers if the first and the second options were not exercised,
wherein the remaining wager is the sum of two of the three wagers if one of the first and the second options was exercised and if the other of the first and the second options was not exercised, and
wherein the remaining wager is equal to one of the three wagers if both of the first and the second wagers were exercised.

2. The method of claim 1 wherein the generating of the present first random number and the present second random number using the at least one random number generating device comprises generating the present first random number using a first random number generating device and generating the second random number using a second random number generating device, wherein the first random number generating device and the second random number generating device are different devices.

3. The method of claim 1 wherein the generating of the present first random number and the present second random number using the at least one random number generating device comprises generating the present first random number and the present second random number using no more than one random number generating device.

4. The method of claim 1 wherein each of the at least one random number generating device and the third random number generating device is comprised of one of:
an electronic, processor-driven random number generator;
a mechanical random number generator;
an electro-mechanical random number generator;
a roulette wheel;
a plurality of disk-shaped objects that are configured to be flipped;
a spinner;
a book containing a table of random numbers;
a mechanical reel configured to revolve and to display indicia corresponding to numerical values;
a plurality of physical tokens configured to be extracted from a container or surface and having indicia corresponding to numerical values; and
a plurality of balls having indicia corresponding to numerical values and configured to be disposed in a mixing chamber and to be mechanically mixed.

5. The method of claim 1 wherein each of the three wagers is equal in amount to the others of the three wagers.

6. The method of claim 1 wherein the settling of the remaining wager if the present combined value is equal to the present third random number is the returning of the remaining wager.

7. The method of claim 1 further comprising taking at least a portion of the three wagers if the present combined value is a value of 7,
wherein the taking of the at least the portion of the three wagers occurs after the revealing of the present second random number to the player and prior to the providing of the second option,
wherein the providing of the second option includes providing the second option if the present combined value is not 7,
wherein the generating of the present third random number includes generating the present third random number if the present combined value is not 7,
wherein the paying of the remaining wager if the present combined value is greater than the present third random number and if the prediction is the first game outcome includes paying the remaining wager if the present combined value is not 7,
wherein the paying of the remaining wager if the present third random number is greater than the present combined value and if the prediction is the second game outcome includes paying the remaining wager if the present combined value is not 7, and
wherein the settling of the remaining wager if the present combined value is equal to the present third random number includes settling the remaining wager if the present combined value is not 7.

8. The method of claim 7 wherein the taking of the at least the portion of the three wagers if the present combined value is a value of 7 is one of
taking all of two of the three wagers; and
taking a portion of each of two of the three wagers; and
taking a portion of all of the three wagers if the first option was not exercised.

9. The method of claim 1 wherein the at least one random number generating device is a first die having six faces numbered one through six, and a second die having six faces numbered one through six, and wherein the generating of the present first random number and the present second random number includes rolling the first die and the second die.

10. The method of claim 1 wherein the at least one random number generating device is a die having six faces numbered one through six, wherein the generating of the present first random number and the present second random number includes rolling the die on a first occasion to generate the present first random number and rolling the die on a second occasion to generate the present second random number.

11. The method of claim 1 wherein the third random number generating device is at least one deck of a plurality of cards, wherein each one of the plurality of cards has a point value between 1 and 13, inclusive, and wherein the generating of the present third random number includes dealing one card from the at least one deck of the plurality of cards.

12. The method of claim 11 wherein the at least one deck of the plurality of cards comprises at least one standard deck of 52 playing cards comprising a plurality of King cards, a plurality of Queen cards, a plurality of Jack cards and a plurality of Ace cards, and
wherein each of the plurality of King cards has a value of 13, each of the plurality of Queen cards has a value of 12, each of the plurality of Jack cards has a value of 11, and each of the plurality of Ace cards has a value of 1.

13. The method of claim 1 wherein the paying of the remaining wager if the present combined value is greater than the present third random number and if the prediction is the first game outcome, includes paying the remaining wager at a payout odds of 1:1, and
wherein the paying of the remaining wager if the present third random number is greater than the present combined value and if the prediction is the second game outcome, includes paying the remaining wager at a payout odds of 1:1.

14. The method of claim 1 wherein the settling of the remaining wager if the present combined value is equal to the present third random number, is the returning of the remaining wager, and
wherein the settling of the remaining wager if the present combined value is equal to the present third random number, further includes paying a bonus amount if the present first random number and the present second random number are equal to one another.

15. The method of claim 14 wherein the bonus amount is a multiple one of the three wagers, wherein the multiple is equal to one of a value of three and a value of four.

16. The method of claim 1, wherein the at least one random number generating device is a first deck of cards and a second deck of cards,
wherein the first deck of cards and the second deck of cards each comprises at least one each of an Ace card, a Two card, a Three card, a Four card, a Five card, and a Six card, and wherein the first deck of cards and the second deck of cards include no cards other than the at least one Ace card, the at least one Two card, the at least one Three card, the at least one Four card, the at least one Five card, and the at least one Six card,
wherein the generating of the present first random number and the present second random number includes dealing one card from the first deck of cards to generate the present first random number, and dealing one card from the second deck of cards to generate the present second random number.

17. A method of playing a wagering game comprising:
establishing three wagers by a player,
wherein each of the three wagers is equal in amount to the others of the three wagers,
wherein all of the three wagers are based upon a prediction by the player of one of a first game outcome and a second game outcome,
wherein the first game outcome is a future combined dice value being greater than a future card value,
wherein the second game outcome is the future card value being greater than the future combined dice value, and
wherein the future combined dice value is the sum of a future first die value and a future second die value;
generating a present first die value by rolling a first die and a present second die value by rolling a second die, wherein each of the present first die value and the present second die value is a value between 1 and 6, inclusive;
revealing the present first die value to the player;
providing a first option after the present first die value is revealed, wherein the first option allows the player to retrieve one of the three wagers;
revealing the second die value to the player;
taking two of the three wagers if a present combined dice value is a value of 7, wherein the present combined dice value is a sum of the present first die value and the present second die value;
providing a second option after the second die value is revealed and if the present combined dice value is not 7, wherein the second option allows the player to retrieve another one of the three wagers;
generating a present card value if the present combined dice value is not 7, wherein the present card value is generated by dealing one card from at least one deck of a plurality of cards, wherein each one of the plurality of cards has a point value between 1 and 13, inclusive;
paying a remaining wager if the present combined dice value is greater than the present card value and if the prediction is the first game outcome and if the present combined dice value is not 7;
paying the remaining wager if the present card value is greater than the present combined dice value and if the prediction is the second game outcome and if the present combined dice value is not 7; and
returning the remaining wager if the present combined dice value is equal to the present card value and if the present combined dice value is not 7,
wherein the remaining wager is the sum of the three wagers if the first and the second options were not exercised,
wherein the remaining wager is the sum of two of the three wagers if one of the first and the second options was exercised and if the other of the first and the second options was not exercised, and
wherein the remaining wager is equal to one of the three wagers if both of the first and the second options were exercised.

18. An article of manufacture for use by a player in playing a wagering game and for use by a device having a processing unit, said article of manufacture comprising at least one non-transitory, tangible computer-readable storage medium with an executable program stored therein for use by the processing unit, the executable program being configured to cause the device to perform:
establishing three wagers by the player wherein all of the three wagers are based upon a prediction of one of a first game outcome and a second game outcome,
wherein the first game outcome is a future combined dice value being greater than a future card point value,
wherein the second game outcome is the future card point value being greater than the future combined dice value, and
wherein the future combined dice value is a sum of a future first die value and a future second die value;
displaying a first die showing a present first die value, wherein the present first die value is a first randomly generated value between 1 and 6, inclusive;
providing a first option after the displaying of the first die, wherein the first option allows the player to retrieve one of the three wagers;
displaying a second die showing a present second die value, wherein the present second die value is a second randomly generated value between 1 and 6, inclusive;
providing a second option after the displaying of the second die, wherein the second option allows the player to retrieve another one of the three wagers;
displaying a card showing a present card point value, wherein the present card point value is a third randomly generated value between 1 and 13, inclusive, and wherein the card represents one of a standard deck of 52 playing cards;
paying a remaining wager if a present combined dice value is greater than the present card point value and if the prediction is the first game outcome,
wherein the present combined dice value is a sum of the present first die value and the present second die value;
paying the remaining wager if the present card point value is greater than the present combined dice value and if the prediction is the second game outcome; and
settling the remaining wager if the present combined dice value is equal to the present card point value, wherein the settling of the remaining wager is one of returning the remaining wager and taking the remaining wager and paying the remaining wager,
wherein the remaining wager is the sum of the three wagers if the first and the second options were not exercised,
wherein the remaining wager is the sum of two of the three wagers if one of the first and the second options was exercised and if the other of the first and the second options was not exercised, and
wherein the remaining wager is equal to one of the three wagers if both of the first and the second wagers were exercised.

19. The article of manufacture of claim 18 wherein the settling of the remaining wager if the present combined dice value is equal to the present card point value, is the returning of the remaining wager, and
wherein the settling of the remaining wager if the present combined dice value is equal to the present card point value, further includes paying a bonus amount if the present first die value and the present second die value are equal to one another.

20. The article of manufacture of claim 19 wherein the bonus amount is a multiple one of the three wagers, wherein the multiple is equal to one of a value of three and a value of four.

21. A system for use by a player in playing a wagering game, comprising:
a device having a processing unit capable of executing at least one software routine; and
programming logic configured for execution by the processing unit, wherein the programming logic is operable with the processing unit to perform steps comprising:
establishing three wagers by the player wherein all of the three wagers are based upon a prediction of one of a first game outcome and a second game outcome,
wherein the first game outcome is a future combined dice value being greater than a future card point value,
wherein the second game outcome is the future card point value being greater than the future combined dice value, and
wherein the future combined dice value is a sum of a future first die value and a future second die value;
displaying a first die showing a present first die value, wherein the present first die value is a first randomly generated value between 1 and 6, inclusive;
providing a first option after the displaying of the first die, wherein the first option allows the player to retrieve one of the three wagers;
displaying a second die showing a present second die value, wherein the present second die value is a second randomly generated value between 1 and 6, inclusive;
providing a second option after the displaying of the second die, wherein the second option allows the player to retrieve another one of the three wagers;
displaying a card showing a present card point value, wherein the present card point value is a third randomly generated value between 1 and 13, inclusive, wherein the card represents one of a standard deck of 52 playing cards;
paying a remaining wager if a present combined dice value is greater than the present card point value and if the prediction is the first game outcome,
wherein the present combined dice value is a sum of the present first die value and the present second die value;
paying the remaining wager if the present card point value is greater than the present combined dice value and if the prediction is the second game outcome; and
settling the remaining wager if the present combined dice value is equal to the present card point value, wherein the settling of the remaining wager is one of returning the remaining wager and taking the remaining wager and paying the remaining wager,
wherein the remaining wager is the sum of the three wagers if the first and the second options were not exercised,
wherein the remaining wager is the sum of two of the three wagers if one of the first and the second options was exercised and if the other of the first and the second options was not exercised, and
wherein the remaining wager is equal to one of the three wagers if both of the first and the second wagers were exercised.

22. The system of claim 21 wherein the settling of the remaining wager if the present combined dice value is equal to the present card point value, is the returning of the remaining wager, and
wherein the settling of the remaining wager if the present combined dice value is equal to the present card point value, further includes paying a bonus amount if the present first die value and the present second die value are equal to one another.

23. The system of claim 22 wherein the bonus amount is a multiple one of the three wagers, wherein the multiple is equal to one of a value of three and a value of four.
